(19) United States
(12) Patent Application Publication
(10) Pub. No.: US 2019/0040954 A1
(43) Pub. Date: Feb. 7, 2019

(54) Compressible Gasket, Method for Preparing Same and Electronic Product Comprising Same

(71) Applicant: 3M INNOVATIVE PROPERTIES COMPANY, St. Paul, MN (US)

(72) Inventors: Wei Wei, Bejing (CN); Liang Chen, Shanghai (CN); Jing Fang, Shanghai (CN); Jeffrey W. McCutcheon, Baldwin, WI (US)

(21) Appl. No.: 16/074,784

(22) PCT Filed: Jan. 27, 2017
(86) PCT No.: PCT/US2017/015269

§ 371 Date: Aug. 2, 2018

(30) Foreign Application Priority Data
Feb. 2, 2016 (CN) 201610072990.9

(51) Int. Cl. F16J 15/06; G11B 33/14

(52) U.S. Cl. CPC F16J 15/064; G11B 33/1466

(57) ABSTRACT

The present disclosure provides a compressible gasket, an electronic product comprising the compressible gasket and a method for preparing the compressible gasket. The compressible gasket of the present disclosure comprises an open-cell foam matrix and a filling medium which fills and is cured in the open cells of the open-cell foam, the filling medium comprising a curable adhesive and one or more types of micrometer particles dispersed therein. The one or more types of micrometer particles comprise at least one of thermally conductive micrometer particles and thermally and electrically conductive micrometer particles, and optionally comprise at least one of flame retardant micrometer particles, electrically conductive micrometer particles and electromagnetic wave absorption micrometer particles. The compressible gasket of the present invention can provide shock and vibration absorption and sealing functions and also meet requirements on system thermal management design and/or electromagnetic compatibility design.

### TECHNICAL FIELD

The present disclosure relates to a novel compressible gasket, a method for preparing same and an electronic product comprising same. The novel compressible gasket is mainly used in the market of personal mobile electronic consumer products, such as smart wearable devices, mobile phones, tablet computers, notebook computers to satisfy design requirements of electromagnetic compatibility and system thermal management of the products, and can also be used for electronic and power devices such as automotive electronics, medical electronics and white household appliances which need to satisfy the above functions.

### BACKGROUND OF THE DISCLOSURE

With the wide application of high-frequency and high-performance computing processors in personal mobile electronic devices and the development trend of increasingly thinner structures thereof, effective thermal management design and electromagnetic compatibility design are becoming a focus of and are difficulties faced in personal mobile electronic product design.

In the current electronic material market, single-function electrically conductive compressible gaskets which are widely used by customers cannot satisfy the requirements of research and development engineers on both system thermal management design and electromagnetic compatibility design.

Therefore, there is a need for a compressible gasket, which not only has proper compressibility to absorb shock and vibration and realize a gapless sealing function in a narrow space of an electronic or electrical device, but also has at least one of thermal conductivity, electric conductivity, both thermal and electric conductivity, electromagnetic wave absorption property and flame-retardant property, especially can overcome the defect of inflammability of the electrically conductive compressible gaskets in the current market and has a good flame-retardant property to satisfy customers' special safety design requirements.

### SUMMARY OF THE DISCLOSURE

The present disclosure provides a compressible gasket, which can provide shock and vibration absorption and sealing functions and also meet requirements on system thermal management design and/or electromagnetic compatibility design.

In certain aspects, the present disclosure provides a compressible gasket, which comprises an open-cell foam matrix and a filling medium which fills and is cured in open cells of the open-cell foam, wherein the filling medium comprises a curable adhesive and one or more types of micrometer particles dispersed therein, and the one or more types of micrometer particles comprise at least one of thermally conductive micrometer particles and thermally and electrically conductive micrometer particles, and optionally comprise at least one of flame retardant micrometer particles, electrically conductive micrometer particles and electromagnetic wave absorption micrometer particles.

In certain aspects, the present disclosure provides a method for preparing a compressible gasket, which comprises the following steps: (1) dispersing one or more types of micrometer particles in a curable adhesive to form a flowable filling medium; (2) filling the open cells of an open-cell foam matrix with the flowable filling medium; and (3) curing the filling medium to be cured in the open cells of the open-cell foam matrix by curing the curable adhesive, wherein the one or more types of micrometer particles comprise at least one of thermally conductive micrometer particles and thermally and electrically conductive micrometer particles, and optionally comprise at least one of flame retardant micrometer particles, electrically conductive micrometer particles and electromagnetic wave absorption micrometer particles.

In certain aspects, the present disclosure provides an electronic product, wherein the electronic product comprises the compressible gasket therein.

The compressible gasket provided according to the present disclosure can simultaneously take shock and vibration absorbing and sealing functions of the compressible gasket and requirements on system thermal management design and/or electromagnetic compatibility design into consideration.

### DESCRIPTION OF THE DRAWINGS

In order to enable the above-mentioned and other purposes, features and advantages of the present disclosure to be more obvious and easily understood, the present disclosure will be further described below in combination with the drawings and embodiments.

FIG. 1 is a schematic diagram of a Z-direction contact resistance test of a compressible gasket provided according to certain embodiments of the present disclosure.

FIG. 2 is a schematic diagram of a vertical-direction thermal conductivity coefficient test of a compressible gasket provided according to certain embodiments of the present disclosure.

FIG. 3 shows test results of electromagnetic wave absorption performance (power loss Pₗₒₛₛ) of compressible gaskets in examples 1 and 4 of the present disclosure.

### DESCRIPTION OF THE EMBODIMENTS

It should be understood that one skilled in the art can conceive other various embodiments and make modifications thereto according to the teaching of the description without departing from the range or spirit of the present disclosure. Therefore, the following embodiments do not have a restrictive sense.

Unless otherwise clearly stated, all numbers used for expressing characteristic size, quantity and physical-chemical characteristics in the description and claims shall be understood as modified by the term “about” under all situations. Therefore, unless otherwise contrarily stated, numerical parameters listed in the description and the attached claims are approximate values, and one skilled in the art can properly change these approximate values according to the desired characteristics which can be obtained by the teaching disclosed herein. Numerical value ranges expressed by using end points include all numbers in the ranges and any range in the ranges. For example, 1-5 includes 1, 1.1, 1.3, 1.5, 2, 2.75, 3, 3.80, 4, 5, and the like.

Unless otherwise clearly stated, the “open-cell foaming” described in the present disclosure refers to a foaming process of the open-cell foam material.

Unless otherwise clearly stated, the “open-cell foam material” described in the present disclosure refers to a material obtained by open-cell foaming, wherein the material includes non-independent foam cells which are not isolated from other foam cells in the material by wall membranes and are mutually communicated therewith.

### Compressible Gasket

According to certain aspects, the present disclosure provides a compressible gasket, which comprises an open-cell foam matrix and a filling medium which fills and is cured in the open cells of the open-cell foam, wherein the filling medium comprises a curable adhesive and one or more types of micrometer particles dispersed therein, and the one or more types of micrometer particles comprise at least one of thermally conductive micrometer particles and thermally and electrically conductive micrometer particles, and optionally comprise at least one of flame retardant micrometer particles, electrically conductive micrometer particles and electromagnetic wave absorption micrometer particles.

According to certain embodiments, more than 20%, or more than 30%, or more than 50% or up to 100% of the open-cell volume of the open-cell foam matrix is filled with the filling medium. When the filling percentage reaches more than 20%, the effect of the micrometer particles contained in the filling medium can be fully exerted.

The foam matrix in the compressible gasket provided by the present disclosure has an open-cell foam structure distributed therein, and the shape of the open-cell foam structures is preferably sheet like. The sheet-like open-cell foam mainly plays a role of a skeleton structure to provide tensile strength and support strength, thus providing compressibility while providing a filling space for the filling medium.

The material of the foam matrix is not limited as long as the material has elasticity and has predetermined resilience under the effect of an external force. According to certain embodiments, the open-cell foam matrix is open-cell foam formed from a high-molecular elastic material or a thermal elastomer through a foaming process. According to certain embodiments, the high-molecular elastic material for the open-cell foam matrix is polyurethane, polyvinyl chloride, silicon resin, ethylene vinyl acetate (EVA) copolymer, polyethylene or a mixture thereof.

According to certain embodiments, the thickness of the open-cell foam matrix is 0.1 mm-50 mm, preferably 0.1 mm-10 mm, more preferably 0.5 mm-5 mm or most preferably 1.0 mm-3.0 mm.

According to certain embodiments, the cell density of the open-cell foam matrix is 10 ppi-500 ppi, preferably 50 ppi-300 ppi, more preferably 50 ppi-200 ppi or most preferably 80 ppi-150 ppi.

According to certain embodiments, a metal layer can be deposited on the open-cell foam matrix to further impart electric conductivity and/or magnetic conductivity to the open-cell foam matrix.

According to certain embodiments, the metal layer comprises nickel and cobalt. In certain embodiments, the weight ratio of Co/(Co+Ni) is 0.2%-85%, in one preferred embodiment, the weight ratio is 2%-70%, In one more preferred embodiment, the weight ratio is 5%-50%, and in the most preferred embodiment, the weight ratio is 5%-35%.

When the weight ratio of Co/(Co+Ni) is within the above-mentioned ranges, excellent magnetic performance can be obtained.

According to certain embodiments, the weight ratio of (Co+Ni)/foam of the open-cell foam matrix deposited with nickel and cobalt is 1%-50%, preferably 2%-30%, more preferably 3%-20% or most preferably 5%-10%. The thickness of the deposited metal layer is 10 nm-2000 nm, preferably 50 nm-1800 nm, more preferably 100 nm-1500 nm or most preferably 200 nm-1000 nm.

According to certain embodiments, the metal layer deposited on the open-cell foam matrix further comprises metal such as molybdenum, manganese, copper, chromium and a combination thereof. The weight ratio of total metal/foam of the foam matrix deposited with the metal layer is 1%-50%, preferably 2%-40%, more preferably 3%-30% or most preferably 5%-20%. When the weight ratio of total metal/foam is within the above ranges, resistance, especially the Z-direction resistance can be smaller. The thickness of the deposited metal layer is 10 nm-2000 nm, preferably 50 nm-1800 nm, more preferably 100 nm-1500 nm or most preferably 200 nm-1000 nm. When the thickness of the deposited metal layer is within the above ranges, the resistance, especially the Z-direction resistance can be smaller, and the deposited layer is not easily fallen off or fractured due to repetitive compression.

The filling medium in the compressible gasket provided by the present disclosure is used to fill and be cured in the open cells of the open-cell foam. Since the filling medium therein comprises at least one of the thermally conductive micrometer particles and the thermally and electrically conductive micrometer particles, or further comprises at least one of the flame-retardant micrometer particles, the electrically conductive micrometer particles and the electromagnetic wave absorption micrometer particles, the compressible gasket can overally have thermal conductivity, and can have electric conductivity and electromagnetic wave absorption performance, or have a flame-retardant property.

According to certain embodiments, the thermally conductive micrometer particles comprise at least one of aluminum oxide, boron nitride, silicon oxide, silicon carbide and copper nitride; the thermally and electrically conductive micrometer particles comprise metal powder such as silver powder, aluminum powder and nickel powder, or particles plated with electrically conductive metals on surfaces, such as silver-plated aluminum powder and silver-plated glass powder; the flame-retardant micrometer particles comprise aluminum oxide, aluminum hydroxide and the like; and the electromagnetic wave absorption micrometer particles comprise metallic magnetic absorbent particles such as carbonyl iron powder (CIP), ferrite wave absorption materials such as nickel zinc ferrite, manganese zinc ferrite and barium ferrite, alloy wave absorption materials such as sendust, and ceramic wave absorption materials such as silicon carbide and aluminum borosilicate. According to certain embodiments, the micrometer particles are granular or fibrous.

According to certain embodiments, the size of the micrometer particles can be within a range of 1 μm-1000 μm. With respect to granular micrometer particles, D₅₀ is preferably within a range of 1 μm-500 μm, more preferably 1 μm-100 μm. With respect to fibrous micrometer particles, the average length of fibers is preferably 50 μm-500 μm, more preferably 60 μm-300 μm, or particularly preferably 75 μm-150 μm. According to certain embodiments, the length-diameter ratio of the fibers is 2-20, preferably 5-15.

According to certain embodiments, the micrometer particles in the filling medium are uniformly dispersed in the curable adhesive and are poured into and stably bonded in the open cells of the open-cell foam by virtue of the curing of the curable adhesive.

According to certain embodiments, the curable adhesive comprises a thermocuring adhesive, a hot-melting adhesive and a crosslinking curing adhesive. The curable adhesive can be selected from a group consisting of silica gel, epoxy adhesive, polyurethane adhesive and acrylic acid adhesive. In one preferred embodiment, the curable adhesive is silica gel to improve the high temperature resistance of the entire system, thus providing a better flame-retardant property for the compressible gasket. Further preferably, the silica gel can be liquid bicomponent silica gel.

According to certain embodiments, the mass ratio of the adhesive to the micrometer particles in the filling medium is 99:1-5:99, preferably 50:50-5:95 or more preferably 80:20 to 5:95. Within the ratio ranges, the micrometer particles can be uniformly dispersed in the adhesive, and the cured filling medium can provide required performance such as thermal conductivity and electric conductivity.

According to certain embodiments, other functional layers can also be integrated on the compressible gasket to impart better performance for the compressible gasket or to facilitate use thereof.

According to certain embodiments, other functional layers can comprise an electrically conductive layer or release paper.

According to certain embodiments, in order to impart an impact absorption property and a vibration blocking property to the compressible gasket, while ensuring good tightness when the gasket is being press-fitted into a predetermined gap, the compressible deformation of the compressible gasket is more than 50%, preferably more than 70%, more preferably more than 80% or most preferably more than 90% of initial thickness. The compressible deformation herein is a value under the effect of a force not more than 50 PSI.

According to certain embodiments, the compressible gasket has certain resilience, and the residual deformation (permanent deformation) of the compressible gasket is less than 50%, preferably less than 30%, more preferably less than 20% or most preferably less than 10% upon the removal of the external force from the compressible gasket.

According to certain embodiments, in order to enable the compressible gasket to have enough thermal conductivity, the vertical thermal conductivity coefficient of the compressible gasket measured according to ASTM D-5470-12 is more than 0.50 w/m-k, or preferably more than 0.80 w/m-k.

According to certain embodiments, the compressible gasket passes a UL94 V-0 flame rating test.

### Method for Preparing Compressible Gasket

According to certain aspects, the present disclosure provides a method for preparing a compressible gasket, which comprises the following steps: (1) dispersing one or more types of micrometer particles in a curable adhesive to form a flowable filling medium; (2) filling the open cells of the open-cell foam matrix with the flowable filling medium; and (3) curing the filling medium to be cured in the open cells of the open-cell foam matrix by curing the curable adhesive, wherein the one or more types of micrometer particles comprise at least one of thermally conductive micrometer particles and thermally and electrically conductive micrometer particles, and optionally comprise at least one of flame retardant micrometer particles, electrically conductive micrometer particles and electromagnetic wave absorption micrometer particles.

According to certain embodiments, the open-cell foam matrix for preparing the compressible gasket is open-cell foam formed from a high-molecular elastic material or a thermal elastomer through a foaming process. The high-molecular elastic material for the open-cell foam matrix is polyurethane, polyvinyl chloride, silicon resin, ethylene vinyl acetate (EVA) copolymer, polyethylene or a mixture thereof.

According to certain embodiments, the sheet open-cell foam matrix for preparing the compressible gasket can be prepared by performing the following steps: polymerizing and foaming the high-molecular elastic material such as polyurethane to form an open-cell foam body, i.e., open-cell foam, and then cutting the open-cell foam into sheet-like open-cell foam with a specified thickness.

According to certain embodiments, electric conduction treatment can be further performed on the sheet-like open-cell foam to obtain sheet-like electrically conductive open-cell foam deposited with a metal layer on the surface. The electric conduction treatment can comprise metal vapor deposition, metal magnetron sputtering, metal solution electroplating, metal solution chemical plating or a combination thereof.

With respect to the description of the metal layer deposited on the open-cell foam matrix, refer to the “Compressible gasket” part in the description.

In the present disclosure, the compressible gasket is prepared by filling and curing the filling medium which comprises a curable adhesive and one or more types of micrometer particles dispersed therein into the open cells of the open-cell foam, wherein, first the flowable filling medium is formed, then the flowable filling medium fills the open cells of the open-cell foam matrix, and finally the filling medium to be cured is cured in the open cells of the open-cell foam matrix by curing the curable adhesive.

According to certain embodiments, the flowable filling medium is formed by dispersing one or more types of micrometer particles in the curable adhesive. In order to enable the micrometer particles to be uniformly dispersed therein by means of agitation or the like, the adhesive used is in a liquid state.

According to certain embodiments, the curable adhesive comprises a thermocuring adhesive, a hot-melting adhesive and a radiation curing adhesive. Such adhesive can be in a liquid state at room temperature, or can be in a liquid state when heated, such as a hot-melting adhesive.

According to certain embodiments, filling the open cells of the open-cell foam matrix with the filling medium comprises pouring the flowable filling medium onto the open-cell foam and then pressing the filling medium into the open cells of the open-cell foam; or impregnating the open-cell foam into the flowable filling medium, and then taking out the impregnated open-cell foam and removing the filling medium outside the open cells.

According to certain embodiments, the curing of the curable adhesive comprises heating curing, radiation curing or (low-temperature) solidification of a hot-melting adhesive.

With respect to the detailed description of the adhesive, the micrometer particles and the ratio thereof, refer to the “Compressible gasket” part in the description.

### Electronic Product

According to certain aspects, the present disclosure provides an electronic product comprising the compressible gasket of the present disclosure.

According to certain embodiments, the electronic product comprises smart wearable devices, mobile phones, computers, automotive electronics, medical electronics and white household appliances.

The following embodiments are used to exemplarily rather than restrictively describe the present disclosure.

Embodiment 1 is a compressible gasket, which comprises an open-cell foam matrix and filling medium which fills and is cured in the open cells of the open-cell foam, wherein the filling medium comprises a curable adhesive and one or more types of micrometer particles dispersed therein, and the one or more types of micrometer particles comprise at least one of thermally conductive micrometer particles and thermally and electrically conductive micrometer particles, and optionally comprise at least one of flame retardant micrometer particles, electrically conductive micrometer particles and electromagnetic wave absorption micrometer particles.

Embodiment 2 is the compressible gasket according to embodiment 1, wherein more than 20%, or more than 30%, or more than 50%, or up to 100% of the open-cell volume of the open-cell foam matrix is filled with the filling medium.

Embodiment 3 is the compressible gasket according to embodiment 1 or 2, wherein the open-cell foam matrix is open-cell foam formed from a high-molecular elastic material or a thermal elastomer through a foaming process.

Embodiment 4 is the compressible gasket according to embodiment 3, wherein the high-molecular elastic material is polyurethane, polyvinyl chloride, silicon resin, ethylene vinyl acetate (EVA) copolymer, polyethylene or a mixture thereof.

Embodiment 5 is the compressible gasket according to any one of embodiments 1-4, wherein a metal layer is deposited on the open-cell foam matrix.

Embodiment 6 is the compressible gasket according to embodiment 5, wherein the metal layer comprises nickel and cobalt.

Embodiment 7 is the compressible gasket according to any one of embodiments 1-6, wherein the curable adhesive comprises a thermocuring adhesive, a hot-melting adhesive and a crosslinking curing adhesive.

Embodiment 8 is the compressible gasket according to any one of embodiments 1-7, wherein the curable adhesive is selected from a group consisting of silica gel, epoxy adhesive, polyurethane adhesive and acrylic acid adhesive.

Embodiment 9 is the compressible gasket according to embodiment 8, wherein the silica gel is liquid bicomponent silica gel.

Embodiment 10 is the compressible gasket according to any one of embodiments 1-9, wherein the thermally conductive micrometer particles comprise at least one of aluminum oxide, boron nitride, silicon oxide, silicon carbide and copper nitride; the thermally and electrically conductive micrometer particles comprise metal powder such as silver powder, aluminum powder and nickel powder or particles plated with electrically conductive metals on surfaces, such as silver-plated aluminum powder and silver-plated glass powder; the flame-retardant micrometer particles comprise aluminum oxide, aluminum hydroxide and the like; and the electromagnetic wave absorption micrometer particles comprise metallic magnetic absorbent particles such as carbonyl iron powder (CIP), ferrite wave absorption materials such as nickel zinc ferrite, manganese zinc ferrite and barium ferrite, alloy wave absorption materials such as sendust, and ceramic wave absorption materials such as silicon carbide and aluminum borosilicate.

Embodiment 11 is the compressible gasket according to any one of embodiments 1-10, wherein the micrometer particles are granular or fibrous.

embodiment 12 is the compressible gasket according to any one of embodiments 1-11, wherein the mass ratio of the adhesive to the micrometer particles in the filling medium is 99:1-5:99, preferably 50:50-5:95 or more preferably 80:20 to 5:95.

Embodiment 13 is the compressible gasket according to any one of embodiments 1-12, wherein the thickness of the open-cell foam matrix is 0.1 mm-50 mm, preferably 0.1 mm-10 mm, more preferably 0.5 mm-5 mm or most preferably 1.0 mm-3.0 mm.

Embodiment 14 is the compressible gasket according to any one of embodiments 1-13, wherein the cell density of the open-cell foam matrix is 10 ppi-500 ppi, preferably 50 ppi-300 ppi, more preferably 50 ppi-200 ppi or most preferably 80 ppi-150 ppi.

Embodiment 15 is the compressible gasket according to any one of embodiments 1-14, wherein the compressible deformation of the compressible gasket is more than 50%, preferably more than 70%, more preferably more than 80% or most preferably more than 90% of initial thickness.

Embodiment 16 is the compressible gasket according to any one of embodiments 1-15, wherein the residual deformation of the compressible gasket is less than 50%, preferably less than 30%, more preferably less than 20% or most preferably less than 10%.

Embodiment 17 is the compressible gasket according to any one of embodiments 1-16, wherein the vertical thermal conductivity coefficient of the compressible gasket measured according to ASTM D-5470-12 is more than 0.50 w/m-k, or preferably more than 0.80 w/m-k.

Embodiment 18 is the compressible gasket according to any one of embodiments 1-17, wherein the compressible gasket passes a UL94 V-0 flame rating test.

Embodiment 19 is the compressible gasket according to any one of embodiments 1-18, wherein the compressible gasket is further integrated with other functional layers.

Embodiment 20 is a method for preparing a compressible gasket, comprising:

(1) dispersing one or more types of micrometer particles in a curable adhesive to form a flowable filling medium;
(2) filling the open cells of an open-cell foam matrix with the flowable filling medium;
(3) curing the filling medium in the open cells of the open-cell foam matrix by curing the curable adhesive,
wherein the one or more types of micrometer particles comprise at least one of thermally conductive micrometer particles and thermally and electrically conductive micrometer particles, and optionally comprise at least one of flame retardant micrometer particles, electrically conductive micrometer particles and electromagnetic wave absorption micrometer particles.

Embodiment 21 is the method according to embodiment 20, wherein the open-cell foam matrix is open-cell foam formed from a high-molecular elastic material or a thermal elastomer through a foaming process.

Embodiment 22 is the method according to embodiment 20 or 21, wherein the open-cell foam matrix is subjected to electric conduction treatment.

Embodiment 23 is the method according to embodiment 22, wherein the electric conduction treatment comprises metal vapor deposition, metal magnetron sputtering, metal solution electroplating, metal solution chemical plating or a combination thereof.

Embodiment 24 is the method according to any one of embodiments 20-23, wherein the curable adhesive comprises a thermocuring adhesive, a hot-melting adhesive and a radiation curing adhesive.

Embodiment 25 is the method according to any one of embodiments 20-24, wherein the thermally conductive micrometer particles comprise at least one of aluminum oxide, boron nitride, silicon oxide, silicon carbide and copper nitride; the thermally and electrically conductive micrometer particles comprise metal powder such as silver powder, aluminum powder and nickel powder, or particles plated with electrically conductive metals on surfaces, such as silver-plated aluminum powder and silver-plated glass powder; the flame-retardant micrometer particles comprise aluminum oxide, aluminum hydroxide and the like; and the electromagnetic wave absorption micrometer particles comprise metallic magnetic absorbent particles such as carbonyl iron powder (CIP), ferrite wave absorption materials such as nickel zinc ferrite, manganese zinc ferrite and barium ferrite, alloy wave absorption materials such as sendust, and ceramic wave absorption materials such as silicon carbide and aluminum borosilicate.

Embodiment 26 is the method according to any one of embodiments 20-25, wherein filling the open cells of the open-cell foam matrix the with the filling medium comprises pouring the flowable filling medium on open-cell foam and then pressing the filling medium into the open cells of the open-cell foam; or impregnating the open-cell foam into the flowable filling medium, and then taking out the impregnated open-cell foam and removing the filling medium outside the open cells.

Embodiment 27 is the method according to any one of embodiments 20-26, wherein the curing of the curable adhesive comprises heating curing, radiation curing or solidification of a hot-melting adhesive.

Embodiment 28 is an electronic product, wherein the electronic product comprises the compressible gasket according to any one of embodiments 1-19 or the compressible gasket prepared using the method according to any one of embodiments 20-27.

Embodiment 29 is the electronic product according to embodiment 28, wherein the electronic product comprises smart wearable devices, mobile phones, computers, automotive electronics, medical electronics and white household appliances.

### EXAMPLES

The examples and comparative examples provided as follows are helpful to understand the present invention. These examples and comparative examples shall not be understood as limitations to the scope of the present invention. Unless otherwise stated, all parts and percentages are in weight.

### I. Raw Materials and Preparation Method

Raw materials used in the examples and comparative examples of the present disclosure and sources thereof are summarized in Table 1.

TABLE 1

| Product Name | Model | Manufacturer |
|---|---|---|
| Polyurethane foam | MF-50P | INOAC CORPORATION |
| Aluminum oxide A | BAK-0700 | Shanghai Bestry Performance |
| (D50 = 70 um) | | Materials Co., Ltd. |
| Aluminum oxide B | BAK-0050 | Shanghai Bestry Performance |
| (D50 = 5 um) | | Materials Co., Ltd. |
| Carbonyl iron | EW | BASF (GERMANY) |
| powder CIP | | |
| Silver plated | SA300S30 | Potters Industries Inc. (USA) |
| aluminum powder | | |
| Liquid organic | XG-3015 | South Korea KCC Organic Silicon |
| silica gel A + B* | | Corporation |

*Liquid organic silica gel A mainly comprises the following components: vinyl-terminated linear silicon oil and organic platinum catalyst; and liquid organic silica gel B mainly comprises the following components: vinyl-terminated linear silicon oil and hydrogen-containing silicon oil containing branched chains.

Parameters of polyurethane foam MF-50P are listed in Table 2 as follows.

TABLE 2

| | Performance parameter |
|---|---|
| Raw material | Polyurethane foam |
| Cell type | Open-cell structure |
| Cell density (ppi) | 110 |
| Thickness (mm) | 1.8 +/− 0.2 |
| Tensile strength | Transverse tensile strength >1.0 |
| (Kg/2 cm) | Longitudinal tensile strength >2.0 |

The method for preparing the electroplated polyurethane foam matrix is as follows:

First, web chemical vacuum deposition pretreatment was performed on the polyurethane foam MF-50P under the following conditions to obtain a nickel plated layer with a nickel coated weight per square meter of 0.15 g/m²-0.20 g/m².
Vacuum degree: about 0.2 Pa;
External temperature of deposition apparatus: room temperature;
Target material: metallically pure nickel.
Thereafter, cobalt and nickel alloy electroplating was performed by using an electroplating solution. For components and component proportions in the electroplating solution, see Table 3. The anode of the electrolytic bath was a nickel plate; the cathode was electroplating pretreated foam; the bath solution temperature was room temperature and the working voltage was lower than 12 V.

TABLE 3

| | |
|---|---|
| NiCl₂ | 30 g-230 g |
| CoCl₂ | 15 g-110 g |
| H₃BO₃ | 1 g-50 g |
| Distilled water | 900 Ml-1000 Ml |

### II. Test Method

The Z-direction electric conductivity of the compressible gasket was evaluated in the present disclosure by using “Z-direction contact resistance of compressible gasket”.

The thermal conductivity of the compressible gasket was evaluated in the present disclosure by using “vertical thermal conductivity coefficient of compressible gasket”. The electromagnetic wave absorption performance of the compressible gasket was evaluated in the present disclosure by using “power loss Pₗₒₛₛ” measured according to IEC62333.

The flame-retardant performance of the compressible gasket was evaluated in the present disclosure by using a “flame rating” measured according to a UL94 vertical flame-retardant test standard.

### Vertical (Z-Direction) Contact Resistance Test of Compressible Gasket

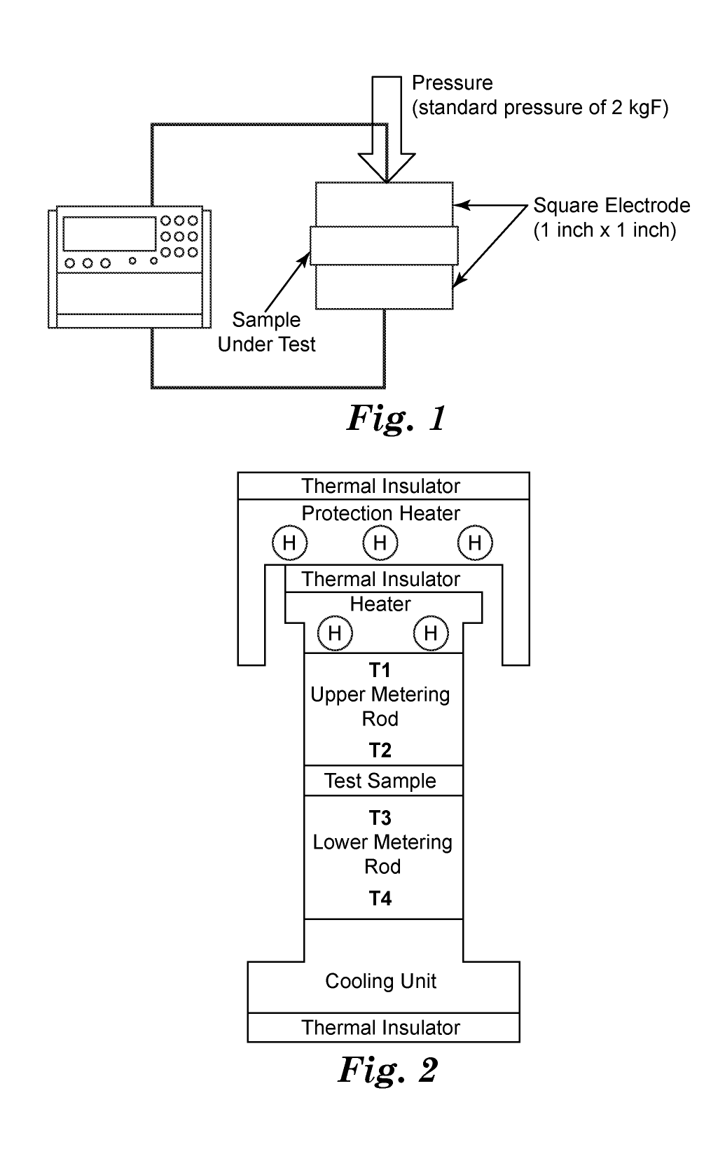

A standard test fixture specified by MIL-G-83528 was used and the fixture electrode was subjected to gold plating treatment. The contact area between the electrode and a sample under test was 25.4 mm×5.4 mm, positive pressure of 2 kg was applied above the electrode, and the two ends were connected to a TTi BS407 precision resistance tester, as shown in FIG. 1.

### Vertical Thermal Conductivity Coefficient Test of Compressible Gasket

A standard test fixture specified by ASTM D-5470-12 was used, and a test sample was a circular sheet with a diameter of 25 mm as shown in FIG. 2.

### Electromagnetic Wave Absorption Performance Test of Compressible Gasket

A standard test fixture specified by IEC62333 was used to test power loss performance. The sample was 100 mm in length and 50 mm in width, and was placed on the surface of a micro-strip line. The parameter S11 (dB) and the parameter S21 (dB) measured by a vector network analyzer were used as data to calculate the power loss Pₗₒₛₛ and to plot.

### Flame-Retardant Property Test of Compressible Gasket

With reference to a UL94 vertical flame-retardant test standard, ignition time was measured based on a test size of 125 mm (length)×13 mm (width)×1.8 mm (thickness).

### Examples 1-5

Compressible gaskets in examples 1-5 of the present disclosure were prepared by using the raw materials and proportions thereof as shown in Tables 4 and 5 according to the following steps.

TABLE 4
Raw materials used in examples 1-5

| | | Non- | Wave | Thermally | Thermally and | Adhesive |
|---|---|---|---|---|---|---|
| | Electroplated | electroplated | absorption | conductive | electrically | (liquid |
| | polyurethane | polyurethane | functional | particle | conductive particle | organic |
| | foam matrix | foam matrix | particle | (aluminum | (silver plated | silica gel |
| Example | (110 PPI) | (110 PPI) | (CIP) | oxide powder) | aluminum powder | A + B) |
| 1 | ✓ | | ✓ | ✓ | | ✓ |
| 2 | ✓ | | | ✓ | | ✓ |
| 3 | ✓ | | | ✓ | ✓ | ✓ |
| 4 | | ✓ | ✓ | ✓ | | ✓ |
| 5 | | ✓ | | ✓ | ✓ | ✓ |

TABLE 5
Proportions of filling media (micrometer particles and adhesives) in examples 1-5

| | Thermally | Thermally | | Thermally and | | |
|---|---|---|---|---|---|---|
| | conductive | conductive | Wave | electrically conductive | | |
| | particle | particle | absorption | particle (silver plated | | |
| | aluminum oxide A | aluminum oxide B | particle (CIP) | aluminum powder) | Liquid organic | Liquid organic |
| Example | (D50 = 70 um) | (D50 = 5 um) | (D50 = 5 um) | (D50 = 40 um) | silica gel A | silica gel B |
| 1 | 28.1% | 0 | 62.7% | 0 | 4.6% | 4.6% |
| 2 | 51.1% | 35.1% | 0 | 0 | 6.9% | 6.9% |
| 3 | 22.1% | 0 | 0 | 61.3% | 8.3% | 8.3% |
| 4 | 28.1% | 0 | 62.7% | 0 | 4.6% | 4.6% |
| 5 | 22.1% | 0 | 0 | 61.3% | 8.3% | 8.3% |

### Compressible Gasket Preparation Process

Step 1: mixing the micrometer particles such as silver plated aluminum powder and liquid organic silica gel in the above table to form mixed slurry, wherein the proportion of the micrometer particles is about 74% in mass percentage.

Step 2: placing a non-electroplated or electroplated sheet-like polyurethane matrix on a PET protection film, passing the PET protection film through a calender, pouring the mixed sample slurry in step 1 onto the foam matrix, and calendering through the calender to enable the slurry to seep into the open-cell foam matrix.

Step 3: baking and curing the sample in step 2 at 100° C. for 10 minutes.

Step 4: after curing, turning over the sheet-like foam matrix and performing process of steps 2 and 3 on the back surface.

After completion of the above steps, five compressible gasket samples in examples 1-5 were prepared.

### Performance Tests and Results

According to the methods described in “Test methods”, the Z-direction electric conductivity, thermal conductivity, electromagnetic wave absorption performance and flame-retardant performance of the compressible gasket samples in examples 1-5 were measured.

Results of vertical (Z-direction) contact resistance tests and vertical (Z-direction) thermal conductivity coefficient tests of examples 1-5 are shown in Table 6.

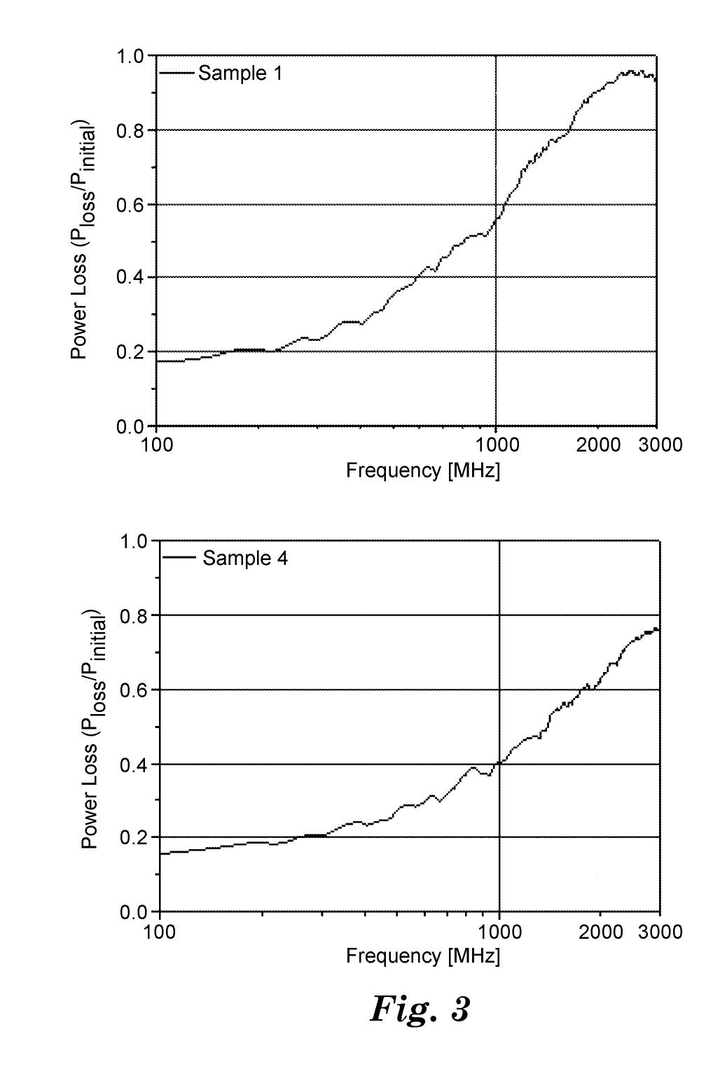

Results of electromagnetic wave absorption performance (power loss Pₗₒₛₛ) tests of examples 1 and 4 are shown in FIG. 3.

Results of flame-retardant performance tests of examples 1-5 are shown in Table 7.

TABLE 6
Results of vertical (Z-direction) contact resistance tests and vertical
(Z-direction) thermal conductivity coefficient tests (average pressure
value during thermal conductivity coefficient tests was 74.7 Kpa)

| | Z-direction thermal | Z-direction contact |
|---|---|---|
| | conductivity coefficient | resistance |
| Example | (w/m-k) | (Ω/inch²) |
| 1 | 1.74 | 0.687 |
| 2 | 1.43 | 0.017 |
| 3 | 1.52 | 0.005 |
| 4 | 1.61 | 2 × 10⁴ |
| 5 | 1.49 | 0.006 |

TABLE 7
Results of flame-retardant performance tests

| Example | UL94 V-0* flame rating test |
|---|---|
| 1 | Pass |
| 2 | Pass |
| 3 | Pass |
| 4 | Pass |
| 5 | Pass |

*According to a UL94 vertical flame-retardant test standard, the samples passed if they did not ignite after more than 10 seconds.

As can be seen from the above results of performance tests, the compressible gaskets in examples 1-5 of the present disclosure have good thermal conductivity and flame-retardant performance, have good electromagnetic wave absorption performance with the addition of the electromagnetic wave absorption micrometer particles, and have good electric conductivity when the electroplated polyurethane foam matrix and/or the electrically conductive micrometer particles are used.

### Comparative Example 1

A compressible gasket in comparative example 1 was prepared by using the same electroplated polyurethane foam matrix as that in examples 1-5, but the electroplated polyurethane foam matrix is free of any filling medium.

Performance tests were performed by using the same methods in the examples, and the performance test results are shown in Table 8 compared to example 2.

TABLE 8
Performance comparison between comparative
example 1 and example 2

| | | Thermal | |
|---|---|---|---|
| | Average | conductivity | |
| | pressure | coefficient | Thickness |
| P/N | (Kpa) | (w/m-k) | (mm) |
| Sample of comparative | 8.5 | 0.09 | 0.67 |
| example 1 | 14.4 | 0.09 | 0.57 |
| (original thickness | 74.7 | 0.10 | 0.43 |
| 1.8 mm) | 159.7 | 0.13 | 0.31 |
| Sample of example 2 | 8.5 | 0.85 | 1.46 |
| (original thickness | 14.4 | 1.17 | 1.25 |
| 1.8 mm) | 74.7 | 1.43 | 0.96 |
| | 159.7 | 1.46 | 0.73 |

According to the results in the table, compared with the sample of comparative example 1, the sample of example 2 with the addition of thermally conductive particles has significantly good thermal conductivity while maintaining compressibility.

To sum up, the compressible gasket of the present disclosure can provide compressibility and also meet the requirements on system thermal management design and/or electromagnetic compatibility design.

Although the above embodiments comprise lots of specific details for the purpose of illustration, one skilled in the art shall understand that various variations, modifications, substitutions and changes of these details are within the scope of the disclosure protected by the embodiments. Therefore, the disclosure described in the embodiments do not constitute any limitation to the present disclosure protected by the embodiments. The proper scope of the present disclosure shall be defined by the claims and the proper legal equivalents thereof. All cited references are incorporated herein by reference in its entirety.

1. A compressible gasket, comprising an open-cell foam matrix and a filling medium which fills and is cured in the open cells of the open-cell foam, wherein the filling medium comprises a curable adhesive and one or more types of micrometer particles dispersed therein, and the one or more types of micrometer particles comprise at least one of thermally conductive micrometer particles and thermally and electrically conductive micrometer particles, and optionally comprise at least one of flame retardant micrometer particles, electrically conductive micrometer particles and electromagnetic wave absorption micrometer particles; wherein a metal layer is deposited on the open-cell foam matrix.

2. The compressible gasket according to claim 1, wherein more than 20%, or more than 30%, or more than 50%, or up to 100% of the open-cell volume of the open-cell foam matrix is filled with the filling medium.

3. The compressible gasket according to claim 1, wherein the open-cell foam matrix is open-cell foam formed from a high-molecular elastic material or a thermal elastomer through a foaming process.

4. The compressible gasket according to claim 3, wherein the high-molecular elastic material is polyurethane, polyvinyl chloride, silicon resin, ethylene vinyl acetate (EVA) copolymer, polyethylene or a mixture thereof.

5. (canceled)

6. The compressible gasket according to claim 5, wherein the metal layer comprises nickel and cobalt.

7. The compressible gasket according to claim 1, wherein the curable adhesive comprises a thermocuring adhesive, a hot-melting adhesive and a crosslinking curing adhesive.

8. The compressible gasket according to claim 1, wherein the curable adhesive is selected from a group consisting of silica gel, epoxy adhesive, polyurethane adhesive and acrylic acid adhesive.

9. The compressible gasket according to claim 8, wherein the silica gel is liquid bicomponent silica gel.

10. The compressible gasket according to claim 1, wherein the thermally conductive micrometer particles comprise at least one of aluminum oxide, boron nitride, silicon oxide, silicon carbide and copper nitride; the thermally and electrically conductive micrometer particles comprise metal powder such as silver powder, aluminum powder and nickel powder or particles plated with electrically conductive metals on surfaces, such as silver-plated aluminum powder and silver-plated glass powder; the flame-retardant micrometer particles comprise aluminum oxide and aluminum hydroxide; and the electromagnetic wave absorption micrometer particles comprise metallic magnetic absorbent particles such as carbonyl iron powder (CIP), ferrite wave absorption materials such as nickel zinc ferrite, manganese zinc ferrite and barium ferrite, alloy wave absorption materials such as sendust, and ceramic wave absorption materials such as silicon carbide and aluminum borosilicate.

11. The compressible gasket according to claim 1, wherein the micrometer particles are granular or fibrous.

12. The compressible gasket according to claim 1, wherein the mass ratio of the adhesive to the micrometer particles in the filling medium is 99:1-5:99, preferably 50:50-5:95 or more preferably 80:20-5:95.

13. The compressible gasket according to claim 1, wherein the thickness of the open-cell foam matrix is 0.1 mm-50 mm, preferably 0.1 mm-10 mm, more preferably 0.5 mm-5 mm or most preferably 1.0 mm-3.0 mm.

14. The compressible gasket according to claim 1, wherein the cell density of the open-cell foam matrix is 10 ppi-500 ppi, preferably 50 ppi-300 ppi, more preferably 50 ppi-200 ppi or most preferably 80 ppi-150 ppi.

15. The compressible gasket according to claim 1, wherein the compressible deformation of the compressible gasket is more than 50%, preferably more than 70%, more preferably more than 80% or most preferably more than 90% of initial thickness.

16. The compressible gasket according to claim 1, wherein the residual deformation of the compressible gasket is less than 50%, preferably less than 30%, more preferably less than 20% or most preferably less than 10%.

17. The compressible gasket according to claim 1, wherein the vertical thermal conductivity coefficient of the compressible gasket measured according to ASTM D-5470-12 is more than 0.50 w/m-k, or preferably more than 0.80 w/m-k.

18. The compressible gasket according to claim 1, wherein the compressible gasket passes a UL94 V-0 flame rating test.

19. The compressible gasket according to claim 1, wherein the compressible gasket is further integrated with other functional layers.

20. A method for preparing a compressible gasket, comprising:
(1) dispersing one or more types of micrometer particles in a curable adhesive to form a flowable filling medium;
(2) filling the open cells of an open-cell foam matrix with the flowable filling medium;
(3) curing the filling medium in the open cells of the open-cell foam matrix by curing the curable adhesive,
wherein the one or more types of micrometer particles comprise at least one of thermally conductive micrometer particles and thermally and electrically conductive micrometer particles, and optionally comprise at least one of flame retardant micrometer particles, electrically conductive micrometer particles and electromagnetic wave absorption micrometer particles.

21. The method according to claim 20, wherein the open-cell foam matrix is open-cell foam formed from a high-molecular elastic material or a thermal elastomer through a foaming process.

22-29. (canceled)
